(19) United States
(12) Patent Application Publication
(10) Pub. No.: US 2003/0054846 A1
(43) Pub. Date: Mar. 20, 2003

(54) Apparatus and methods for selectively establishing wireless communications

(75) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(73) Assignee: Cvsht

(21) Appl. No.: 09/952,261

(22) Filed: Sep. 14, 2001

(51) Int. Cl. H04B 7/00

(52) U.S. Cl. 455/517; 455/509; 455/500

(57) ABSTRACT

Apparatus and methods for establishing communications with a selected wireless communication device from among one or more available communication devices are useful in managing wireless communications. For transmissions containing header information indicative of an identity of the originating device, the header information is extracted and presented to a user of a first wireless communication device in a user-selectable format. In response to a user selection of an instance of the header information, the first wireless communication device is tuned to receive and decode transmissions from the wireless communication device corresponding to the selected instance of the header information. In a like manner, the first wireless communication may further be tuned to encode and transmit information using a communication protocol of the wireless communication device corresponding to the selected instance of the header information. Filters may be employed to limit or alter presentation of header information to the user.

### TECHNICAL FIELD OF THE INVENTION

The present invention relates generally to wireless communications, and in particular to apparatus and methods for selectively establishing wireless communications in response to a user selection of information extracted from wireless transmissions.

### BACKGROUND OF THE INVENTION

Wireless communication devices, including receivers, transmitters and transceivers, are becoming increasingly popular. From mobile phones to personal digital assistants (PDAs) to personal computers (PCs) and their peripherals, people are enjoying the ability to communicate without the need for direct cabling.

To facilitate such communications, a variety of wireless communication protocols have been, and are being, developed. Examples include the Bluetooth™ protocol, the Institute of Electrical and Electronics Engineers, Inc. (IEEE) Standard 802.11, and the Ultra Wide Band (UWB) protocol.

While these protocols are greatly simplifying communications without the need for dedicated cabling, the resulting network of devices may be transient. The user may further be deluged with a large variety of devices providing or requesting services. While some protocols allow for the discovery of available services through a request/response procedure, such procedures are generally incapable of providing notification of whether a service is available without first establishing duplex communications with the service providers.

For the reasons stated above, and for other reasons stated below that will become apparent to those skilled in the art upon reading and understanding the present specification, there is a need in the art for alternative methods and apparatus for selectively establishing wireless communications from among available services.

### SUMMARY

Apparatus and methods for establishing communications with a selected wireless communication device from among one or more available communication devices are useful in managing wireless communications. For transmissions containing header information indicative of an identity of the originating device, the header information is extracted and presented to a user of a first wireless communication device in a user-selectable format. In response to a user selection of an instance of the header information, the first wireless communication device is tuned to receive and decode transmissions from the wireless communication device corresponding to the selected instance of the header information. In a like manner, the first wireless communication may further be tuned to encode and transmit information using a communication protocol of the wireless communication device corresponding to the selected instance of the header information. Filters may be employed to limit or alter presentation of header information to the user.

For one embodiment, the invention provides a wireless communication device. The device includes a first receiver adapted to receive and decode wireless transmissions from one or more other wireless communication devices using at least one wireless communication protocol, a header processor adapted to extract header information from the decoded wireless transmissions, and a first output for providing the extracted header information to a user of the wireless communication device in a user-selectable format. The device further includes a second receiver adapted to receive and decode wireless transmissions using the at least one wireless communication protocol. The second receiver is tunable to selectively receive and decode wireless transmissions from the other wireless communication device associated with extracted header information selected by the user from the first output.

For another embodiment, the invention provides a method of communicating with one or more wireless communication devices. The method includes receiving information indicative of an identity of the wireless communication devices, presenting the information to a user in a user-selectable format, and presenting wireless communications from a selected one of the one or more wireless communication devices to a user in response to a user selection of the information presented to the user. The selected information is indicative of the identity of the selected wireless communication device.

For yet another embodiment, the invention provides a method of operating a wireless communication device. The method includes scanning for wireless transmissions using at least one wireless communication protocol and extracting information from any discovered wireless transmissions. The information is indicative of an identity of a wireless communication device generating the discovered wireless transmissions. The method further includes presenting the extracted information to a user of the wireless communication device, selecting an instance of the extracted information by the user, and providing the wireless transmissions from one of the wireless communication devices to the user. This wireless communication device corresponds to the instance of the extracted information selected by the user.

Further embodiments of the invention include apparatus and methods of varying scope.

### BRIEF DESCRIPTION OF THE DRAWINGS

FIG. 1 is a schematic of a network of wireless communication devices in accordance with an embodiment of the invention.

FIG. 2 is a schematic of a wireless communication device in accordance with an embodiment of the invention.

FIG. 3 is an example of the presentation of information to a user in a user-selectable format in accordance with an embodiment of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

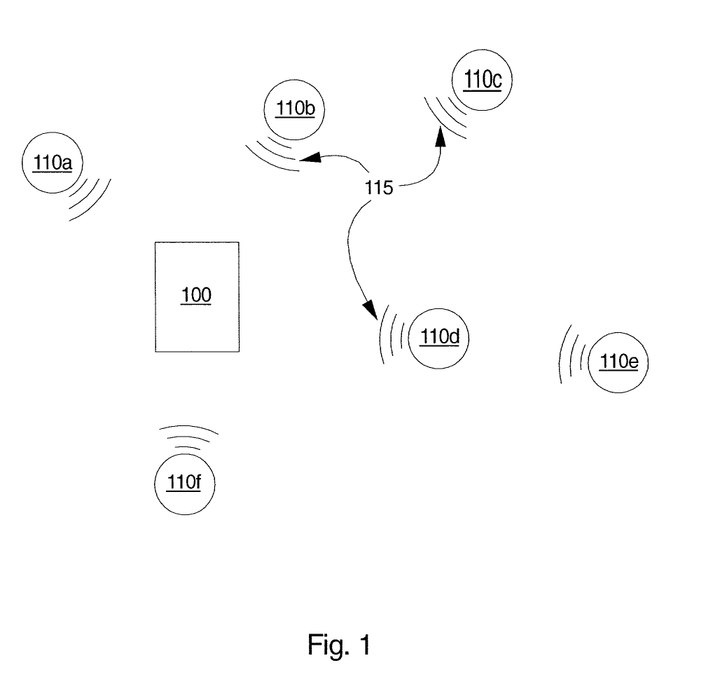

FIG. 1 is a schematic of a network of wireless communication devices. The network includes a first wireless communication device 100 in accordance with an embodiment of the invention. The wireless communication device 100 may be simply a receiver of wireless communications or it may be a transmitter/receiver (transceiver) of wireless communications. Wireless communications include radio frequency (RF) communications, infrared (IR) communications, microwave communications and other techniques for communicating between devices without the need for a physical connection.

In FIG. 1, one or more other wireless communication devices 110 (e.g., 110a-110f) are transmitting wireless transmissions 115. The other wireless communication devices 110 may be simply transmitters of wireless communications or they may be transceivers. The wireless communication devices 110 may transmit using the same wireless communication protocol. Alternatively, the wireless communication devices 110 may transmit using more than one wireless communication protocol. As an example, wireless communication devices 110a and 110b may transmit using a first wireless communication protocol, wireless communication devices 110c and 110d may transmit using a second wireless communication protocol different from the first wireless communication protocol, and wireless communication devices 110e and 110f may transmit using a third wireless communication protocol different from both the first and second wireless communication protocols.

The wireless communication device 100 is adapted to receive wireless transmissions 115 using one or more of the communication protocols. The wireless communication device 100 may be capable of communicating using each communication protocol of the wireless communication devices 110. However, there is no requirement that the wireless communication device 100 be capable of transmitting or understanding wireless communications of any of the wireless communication devices 110 within its range of transmission or reception.

The wireless transmissions 115 include information regarding the device 110 that is generating the corresponding wireless transmission, typically referred to as header information. Often, these wireless transmissions are packetized. In other words, the data contained in the transmission is broken into portions of uniform length or size. These portions are combined with the header information and other information, as determined by the communication protocol being used, into packets of uniform length or size. Alternatively, the header information may be transmitted in a channel or frequency separate from the data. Other methods of associating the header information with the transmission data are also possible. The communication protocol will define the correspondence between the header information and the data contained within a transmission.

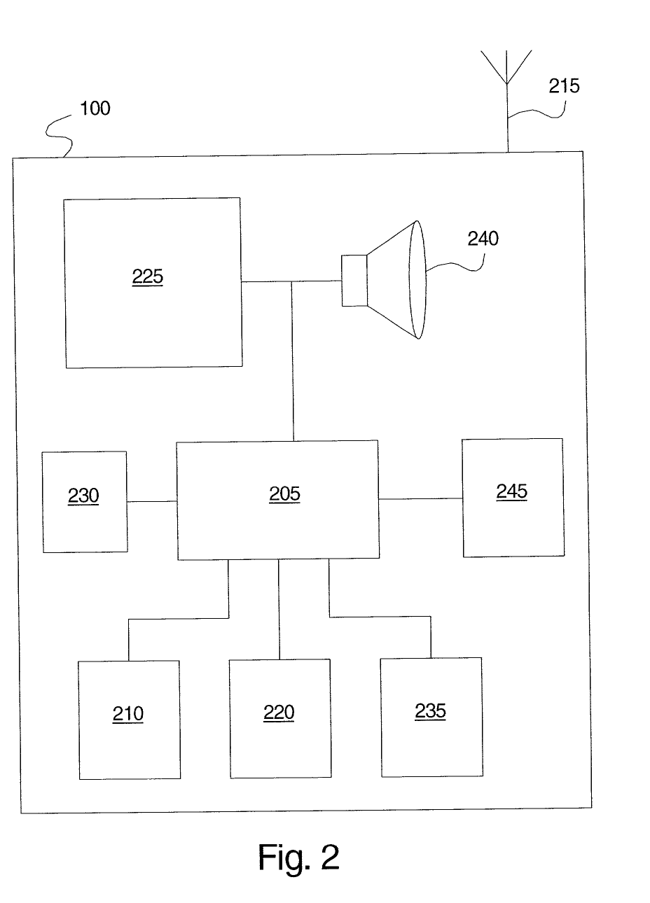

FIG. 2 is a schematic of a wireless communication device 100 in accordance with an embodiment of the invention. The device 100 includes a processor 205, such as a microprocessor, for controlling the operation of the device 100 and its components in response to inputs received by the device 100 and in response to computer-readable instructions, such as software or firmware, stored on a computer-usable medium. Some examples of computer-usable media include static or dynamic random access memory (SRAM or DRAM), read-only memory (ROM), electrically-erasable programmable ROM (EEPROM), magnetic media and optical media, whether permanent or removable from the device 100.

The device 100 further includes a first receiver 210 for receiving and decoding wireless transmissions using an antenna 215. The antenna 215 may include multiple antennas for receiving more than one type of wireless transmission. As an example, the antenna 215 may include an antenna for receiving RF transmissions and an antenna for receiving microwave transmissions. Likewise, the first receiver 210 may include multiple receivers for receiving and decoding more than one type of wireless transmission.

For one embodiment, the first receiver 210 is a scanning receiver. As such, it may periodically scan for transmissions 115 received at the antenna 215. As an example, the first receiver 210 may scan a range of frequencies in an RF communication protocol and/or a range of wavelengths in a microwave communication protocol. Alternatively, the first receiver 210 may only scan for or receive transmissions 115 as directed by the processor 205 in response to instructions, either from a user of the device 100 or from the computer-readable instructions stored on an associated computer-usable medium.

The device 100 further includes a header processor 220. The header processor 220 extracts the header information from the transmissions 115. The header information includes information indicative of the identity of the device 110 originating the transmission containing the header information.

The extracted header information may be presented to a user of the device 100 through an output 225 of the device 100. The output 225 may be a visible display, such as a liquid-crystal display (LCD), a cathode ray tube (CRT) display, a light-emitting diode (LED) display or other visible display. While a visible display is preferred, it is not necessary. As examples, the output 225 may include other types of outputs including audible or tactile outputs.

The output 225 is adapted to present the extracted header information to a user of the device 100 in a user-selectable format. For example, the device 100 may include or otherwise be adapted to communicate with a user input device 230. The user input device 230 may include such things as an alphanumeric keyboard, a numeric keypad and/or a pointing device, as well as other input devices. By presenting the extracted header information on the output 225, the user may use the user input device 230 to select header information corresponding to one of the transmission devices 110. For example, the user could enter a letter or number corresponding to the desired header information using a keyboard or keypad, or the user could use a pointing device or cursor control keys to highlight and select the desired instance of the header information. As a further example, the user could select the desired instance of the header information user a microphone as the user input device 230 along with voice recognition software run by the processor 205. Alternatively, the user input device 230 could be a portion of the output 225. For example, the output 225 could be a touch-screen display with the user input device 230 being the face of the display. By presenting the extracted header information on the output 225, the user could use a finger or stylus to select the desired instance of the displayed information.

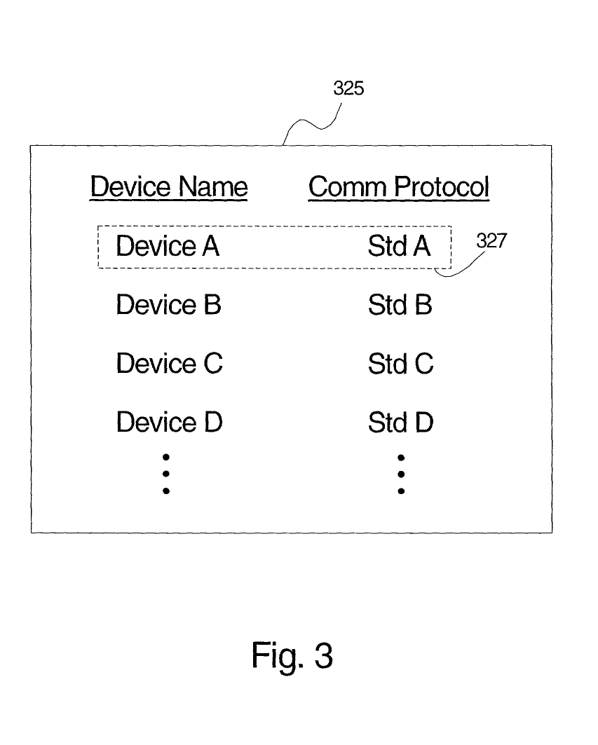

FIG. 3 is an example of the presentation of information to a user in a user-selectable format. The display 325 includes information indicative of the identity of the device associated with the displayed information. The information indicative of the identity may be a device name, a device address or serial number, an identification of a service offered by the device or some other identifier. An instance 327 of the information includes information indicative of the identity of the device, but it may also include supplemental information not indicative of the identity of the device. Examples of supplemental information include the communication protocol used by the transmitting device, a signal strength of the received signal, an estimated distance of the transmitting device, a channel number of the received signal, a frequency or wavelength of the received signal, an indication of permissions obtained from or required by the transmitting device, etc.

Returning to FIG. 2, the device 100 further includes a second receiver 235 for receiving and decoding wireless transmissions from the wireless communication device 110 associated with the selected header information. The second receiver 235 may be a receiver separate and distinct from the first receiver 210. Alternatively, the first receiver 210 and the second receiver 235 may be the same receiver. In response to the user selection of an instance of the displayed header information, the processor 205 tunes the second receiver 235 to receive and decode wireless transmissions from the wireless communication device 110 corresponding to the user-selected header information. The second receiver 235 may receive and decode wireless transmissions from other wireless communication devices 110, but preferably only those transmissions corresponding to the selected wireless communication device 110 are presented to the user.

Upon receiving and decoding the wireless transmissions from the device 110 corresponding to the user-selected header information, the transmissions may be presented to the user using a second output 240. The second output 240 may be an output separate and distinct from the first output 225. For example, the output 225 may be an LCD display while the second output 240 is an audio speaker. Alternatively, the first output 225 and the second output 240 may be the same output.

In addition to selectively receiving wireless transmissions 115 from one or more wireless communication devices 110, the wireless communication device 100 may further selectively carry on duplex communications with the devices 110. For example, the device 100 may further include a transmitter 245 adapted to encode and transmit communications using the antenna 215. The transmitter 245 may be capable of transmitting using each communication protocol that the first receiver 210 is capable of receiving. Alternatively, the transmitter 245 may be capable of transmitting using more or fewer communication protocols. As with the second receiver 235, in response to the user selection of an instance of the displayed header information, the processor 205 may tune the transmitter 245 to encode and transmit wireless transmissions using the communication protocol of the wireless communication device 110 corresponding to the user-selected header information.

For one embodiment, the device 100 is a portable wireless communication device. The output 225 and user input device 230 are an LCD touch-screen display such as is commonly found on PDAs. The output 240 is an audio speaker. The antenna 215, the first receiver 210 and the second receiver 235 are adapted to receive wireless transmissions using the Bluetooth™ protocol, the IEEE 802.11 protocol and the UWB protocol. The antenna 215 and the transmitter 245 are further adapted to transmit wireless transmissions using the Bluetooth™ protocol, the EEE 802.11 protocol and the UWB protocol. The first receiver 210 scans the RF frequencies associated with the communication protocols, capturing and decoding received signals that are compliant with one of its communications protocols. For each transmission that is discovered and decoded, the header processor 220 extracts the header information and can display it to a user of the device 100 on its display 225. The user can touch the instance of the displayed information, thereby selecting the instance of the information. In response to the selection, the processor 205 tunes the second receiver 235 to receive and decode the transmissions corresponding to the selected information, and to provide those transmissions to the user through the second output 240.

While the device 100 may display extracted header information for each transmission received by the device 100, the processor 205 may apply one or more filters to the extracted header information to limit or alter the information displayed to the user. These filters may be user-defined or they may be defined by software or firmware associated with the processor 205. The filters identify those instances of header information containing some predefined characteristic. The action of a filter may be to only allow those instances of header information containing some predefined characteristic to be displayed. Alternatively, the action of a filter may be to prohibit those instances of header information containing some predefined characteristic from being displayed. Still further, the action of the filter may be to highlight those instances of header information containing some predefined characteristic or to otherwise alter the form of their presentation.

As one example of the use of a filter, a device 100 may be adapted to receive communications using the Bluetooth™ and the IEEE 802.11 protocols, but a user may only wish to see a display of header information for devices transmitting using the Bluetooth™ protocol. The filter could either be employed to block reception of transmissions from non-Bluetooth™ devices, thereby blocking display of any information corresponding to those devices. Alternatively, it could allow reception of the transmissions, but merely block their display.

As another example, a device 100 may be adapted to receive communications using the Bluetooth™ and the IEEE 802.11 protocols. The filter could be employed to alter the form of the presented information. For example, the header information associated with Bluetooth™ devices could be presented in a first color or shade on a display while the displayer header information associated with IEEE 802.11 devices could be presented in a second color or shade on the display.

Similar examples can easily be constructed for displaying, blocking or altering the form of display based on other considerations or information. Such examples include blocking display of device information where a user lacks appropriate permissions to communicate with the device, blocking display of device information for encrypted transmissions, blocking display of device information for devices having weak signal strength or having estimated distances above some threshold, allowing display of device information only for those devices in a predefined list of device names, allowing display of device information only for those devices offering a specific type of service, etc. Furthermore, where more than one filter is employed, Boolean or other logical operators may be used in conjunction with the filters.

The presented header information may be periodically refreshed such that the list is dynamic with devices dropping from the list as they stop transmitting or go out of range and with devices being added to the list as they are newly discovered. Alternatively, the list may only be refreshed upon a user request.

### CONCLUSION

Apparatus and methods for establishing communications with a selected wireless communication device from among one or more available communication devices have been described. For transmissions containing header information indicative of an identity of the originating device, the header information is extracted and presented to a user of a first wireless communication device in a user-selectable format. In response to a user selection of an instance of the header information, the first wireless communication device is tuned to receive and decode transmissions from the wireless communication device corresponding to the selected instance of the header information. In a like manner, the first wireless communication may further be tuned to encode and transmit information using a communication protocol of the wireless communication device corresponding to the selected instance of the header information. Filters may be employed to limit or alter presentation of header information to the user.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A wireless communication device, comprising:
a first receiver adapted to receive and decode wireless transmissions from one or more other wireless communication devices using at least one wireless communication protocol;
a header processor adapted to extract header information from the decoded wireless transmissions;
a first output for providing the extracted header information to a user of the wireless communication device in a user-selectable format; and
a second receiver adapted to receive and decode wireless transmissions using the at least one wireless communication protocol, wherein the second receiver is tunable to selectively receive and decode wireless transmissions from the other wireless communication device associated with extracted header information selected by the user from the first output.

2. The wireless communication device of claim 1, wherein the first receiver and the second receiver are the same receiver.

3. The wireless communication device of claim 1, wherein the first output is selected from the group consisting of a visible display, an audible output and a tactile output.

4. The wireless communication device of claim 1, further comprising:
a second output for presenting wireless transmissions from the other wireless communication device associated with the extracted header information selected by the user from the first output.

5. The wireless communication device of claim 4, further comprising:
a processor, wherein the processor is adapted to filter the extracted header information to limit or alter the presentation of the extracted header information to the user in response to one or more filters.

6. The wireless communication device of claim 4, wherein the first output and the second output are the same output.

7. The wireless communication device of claim 1, wherein the first output and the second output are each selected from the group consisting of a visible display, an audible output and a tactile output.

8. The wireless communication device of claim 1, further comprising:
a transmitter adapted to transmit wireless communications using the at least one wireless communication protocol.

9. The wireless communication device of claim 1, wherein the at least one wireless communication protocol comprises a first wireless communication protocol and a second wireless communication protocol different from the first communication protocol.

10. The wireless communication device of claim 9, wherein at least one wireless communication protocol is selected from the group consisting of a Bluetooth™ protocol, an IEEE 802.11 protocol and a UWB protocol.

11. A method of communicating with one or more wireless communication devices, comprising:
receiving information indicative of an identity of the wireless communication devices;
presenting the information to a user in a user-selectable format; and
presenting wireless communications from a selected one of the one or more wireless communication devices to a user in response to a user selection of the information presented to the user, wherein the selected information is indicative of the identity of the selected wireless communication device.

12. The method of claim 11, wherein receiving information indicative of an identity of the wireless communication devices further comprises:
receiving wireless transmissions from each of the wireless communication devices; and
extracting header information from the received wireless transmissions;
wherein the header information contains the information indicative of the identity of the wireless communication devices.

13. The method of claim 12, wherein receiving wireless transmissions from each of the wireless communication devices further comprises scanning wireless transmissions from one or more wireless communication devices using one or more wireless communication protocols.

14. The method of claim 11, further comprising:
filtering the information prior to presenting information to the user using one or more filters to limit or alter the presentation of the information to the user.

15. The method of claim 14, further comprising:
applying logical operators to the one or more filters.

16. The method of claim 14, wherein the filters are based on one or more considerations selected from the group consisting of an existence of appropriate permissions to communicate with a transmitting device, an encryption of a wireless transmission, a signal strength of a wireless transmission, an estimated distance of a transmitting device, a predefined list of device names, and a specific type of service offered by a transmitting device.

17. A method of operating a wireless communication device, comprising:
scanning for wireless transmissions using at least one wireless communication protocol;
extracting information from any discovered wireless transmissions, wherein the information is indicative of an identity of a wireless communication device generating the discovered wireless transmissions;
presenting the extracted information to a user of the wireless communication device;
selecting an instance of the extracted information by the user; and
providing the wireless transmissions from one of the wireless communication devices to the user, wherein this wireless communication device corresponds to the instance of the extracted information selected by the user.

18. The method of claim 17, further comprising:
filtering the extracted information prior to presenting extracted information to the user.

19. The method of claim 18, further comprising:
performing an action on the presentation of the extracted information selected from the group consisting of allowing display, blocking display or altering a form of display of the extracted information.

20. The method of claim 17, wherein the wireless communication device is a portable wireless communication device.
